(19) United States
(12) Patent Application Publication
(10) Pub. No.: US 2022/0355723 A1
(43) Pub. Date: Nov. 10, 2022

(54) ILLUMINATION AND DETECTION LAMP ASSEMBLY AND VEHICLE

(71) Applicant: HASCO VISION TECHNOLOGY CO., LTD., Shanghai (CN)

(72) Inventors: Tao ZHANG, Shanghai (CN); Bin GE, Shanghai (CN); Zhaoyu CHEN, Shanghai (CN); He ZHU, Shanghai (CN); Wenhui SANG, Shanghai (CN)

(21) Appl. No.: 17/789,678

(22) PCT Filed: Dec. 17, 2020
(86) PCT No.: PCT/CN2020/137272

§ 371 Date: Jun. 28, 2022

(30) Foreign Application Priority Data
Dec. 31, 2019 (CN) 201911418845.1
Dec. 31, 2019 (CN) 201911424659.9

(51) Int. Cl. B60Q 1/00; B60Q 1/06; G01S 17/08; G01S 17/931; G01S 7/481

(52) U.S. Cl. CPC B60Q 1/0023; B60Q 1/06; G01S 17/08; G01S 17/931; G01S 7/4815; G01S 7/4813

(57) ABSTRACT

An illumination and detection lamp assembly (100) and a vehicle. The illumination and detection lamp assembly (100) comprises: a lamp assembly body (110); an illumination light source (121), disposed in the lamp assembly body (110), and used for emitting illumination light to the outside; and a detection signal source, disposed in the lamp assembly body (110), and used for sending a detection signal to the outside to detect the position of an object around the lamp assembly body (110).

### TECHNICAL FIELD

The present disclosure relates to the field of vehicle lighting device, in particular, to a lighting detection lamp assembly and a vehicle.

### BACKGROUND

With the advent of the intelligent era, intelligent driving technology in vehicles has been increasingly studied. In order to assist driving, an adaptive cruise control (ACC) system, an autonomous emergency braking (AEB) system have been adopted by more and more vehicles, the ACC can provide automatic following function for drivers in the process of high-speed driving of vehicles, the AEB can automatically brake when less than a safe distance, so as to ensure a safe travel.

The ACC system continuously scans a road ahead of the vehicle mainly through a position detection device (such as radar) mounted in the front of the vehicle, while a wheel speed sensor collects a vehicle speed signal. When a distance between the host vehicle and the preceding vehicle is too small, the ACC control unit can coordinate with an anti-lock braking system and an engine control system to properly brake wheels and reduce the output power of an engine, so that the host vehicle can always maintain a safe distance from the preceding vehicle. The AEB system adopts the position detection device to measure the distance to the preceding vehicle or the obstacle, and then uses a data analysis module to compare the measured distance with an alarm distance and the safety distance. When the measured distance is less than the alarm distance, an alarm prompt is issued. When the measured distance is less than the safety distance, even before the driver has time to press the brake pedal, the E system is activated, allowing the vehicle to brake automatically. The function of the position detection device is mainly to directly feed back the distance parameter between the detected object and the vehicle itself to the host vehicle to assist driving. Therefore, the setting form of the position detection device has a great influence on the realization of the automatic following function and the avoidance of collision accidents.

At present, the position detection device is usually mounted at a position of a vehicle bumper, which is exposed to the external environment and is easily damaged by collision. In addition, in order to prevent the position detection device from being polluted during driving, a cleaning system is additionally provided in the related art, but the space of the vehicle head itself is very limited, and the additional device will affect the design of the vehicle head itself.

### SUMMARY

In an aspect, the present disclosure provides a lighting detection lamp assembly, which includes: an assembly body; a lighting source provided in the assembly body and configured to emit lighting light to outside; and a detection signal source provided in the assembly body and configured to transmit a detection signal to the outside to detect an orientation of an object around the assembly body.

Further, the detection signal source includes a plurality of detection light sources. The plurality of detection light sources are capable of emitting detection light for detecting the orientation of the object around the assembly body.

Further, the detection signal source includes a first detection light source. The first detection light source is configured to emit first detection light. The first detection light source and the lighting source are combined to form a composite light source. The composite light source is configured to emit the lighting light and the first detection light.

Further, the assembly body includes a first light transmission unit. The first light transmission unit is configured to allow the lighting light and the first detection light to be transmitted through so as to be emitted outward. The lighting detection lamp assembly further includes a first detection receiver provided in the assembly body. A light transmission area is provided on the first light transmission unit at a position corresponding to the first detection receiver. The light transmission area is configured to allow reflected light of the first detection light to be transmitted through so as to be received by the first detection receiver.

Further, the detection signal source further includes a second detection light source. The second detection light source is capable of emitting second detection light for detecting the orientation of the object around the assembly body. A first partition is provided between the second detection light source and the composite light source.

Further, the assembly body includes a second light transmission unit. The second light transmission unit is configured to allow the lighting light, the first detection light, and the second detection light to be transmitted through so as to be emitted outward.

Further, the second light transmission unit is provided with a first adjusting area. The first adjusting area is configured to cause the second detection light to be emitted outward according to a preset pattern.

Further, the first adjusting area is located at an edge of at least part of a side of the second light transmission unit.

Further, the second detection light source is fixed to an inner wall of the assembly body by a first fixing base. The first partition is formed on the first fixing base.

Further, an irradiation width range of one of the first detection light and the second detection light is greater than an irradiation width range of the other of the first detection light and the second detection light; and an irradiation distance of the one is less than an irradiation distance of the other.

Further, the lighting detection lamp assembly further includes a second detection receiver. The second detection receiver is attached to the assembly body and is located outside the second light transmission unit and configured to receive reflected light of the first detection light and reflected light of the second detection light.

Further, the assembly body further includes a first optical design unit. The first optical design unit is configured to converge the lighting light and the first detection light to form a light beam transmitted in the assembly body.

Further, the first optical design unit includes a reflector.

Further, the assembly body further includes a radiator configured to fix the lighting source and provide heat dissipation for the lighting source.

Further, the detection light source includes one or more infrared lasers.

Further, the lighting detection lamp assembly further includes a detection receiver configured to receive a reflected signal of the detection signal.

Further, the detection signal source includes a third detection light source. The third detection light source is capable of emitting third detection light for detecting the orientation of the object around the assembly body. The third detection light source is separated from the lighting source.

Further, the assembly body includes a third light transmission unit. The third light transmission unit is configured to allow the lighting light and the third detection light to be transmitted through so as to be emitted outward.

Further, the third light transmission unit is provided with a second adjusting area. The second adjusting area is configured to cause the third detection light to be emitted outward according to a preset pattern.

Further, the second adjusting area is located at an edge of at least part of a side of the third light transmission unit.

Further, the third detection light source is fixed to an inner wall of the assembly body. A second partition is provided between the third detection light source and the lighting light.

Further, the lighting detection lamp assembly further includes a third detection receiver. The third detection receiver is attached to the assembly body and located outside the third light transmission unit, and configured to receive reflected light of the third detection light.

Further, the assembly body further includes a second optical design unit. The second optical design unit is configured to converge the lighting light to form a light beam transmitted in the assembly body.

Further, the second optical design unit includes a reflector.

Further, a plurality of detection signal sources are provided. At least one detection signal source is configured to transmit a first detection signal with a first width range and a first distance range to the outside, and at least one detection signal source is configured to transmit a second detection signal with a second width range and a second distance range to the outside; wherein the first width range is greater than the second width range, and the first distance range is less than the second distance range.

In another aspect, the present disclosure provides a vehicle, including the lighting detection lamp assembly as described above.

### BRIEF DESCRIPTION OF THE DRAWINGS

FIG. 1 is a schematic view showing an inner structure of a lighting detection lamp assembly according to an embodiment of the present disclosure;

FIG. 2 is a schematic view of the lighting detection lamp assembly shown in FIG. 1, when being provided at the front of a vehicle;

FIG. 3 is a perspective view showing an outer structure of a lighting detection lamp assembly according to another embodiment of the present disclosure;

FIG. 4 is a schematic view showing an inner structure of the lighting detection lamp assembly shown in FIG. 3;

FIG. 5 is a schematic view of the lighting detection lamp assembly shown in FIG. 3, when being provided at the front of a vehicle;

FIG. 6 is a schematic view showing a light emission when the lighting detection lamp assembly shown in FIG. 3 is applied to a vehicle;

FIG. 7 is a schematic view showing an inner structure of a lighting detection lamp assembly according to yet another embodiment of the present disclosure;

FIG. 8 is a perspective view showing an outer structure of the lighting detection lamp assembly shown in FIG. 7; and

FIG. 9 is a schematic view of the lighting detection lamp assembly shown in FIG. 7, when being provided at the front of a vehicle.

### DETAILED DESCRIPTION OF THE EMBODIMENTS

In order to facilitate understanding of the present disclosure, the present disclosure will be described more fully below with reference to the related drawings. The preferred embodiments of the present disclosure are shown in the accompanying drawings. However, the present disclosure may be implemented in many different forms and is not limited to the embodiments described herein. Those of ordinary skill in the art will appreciate that changes and modifications of the various embodiments described herein can be made without departing from the scope of the present disclosure, which is defined by the appended claims. In addition, descriptions of well-known functions and constructions may be omitted for clarity and conciseness.

It should be noted that when an element is referred to as being “fixed to” another element, it can be directly on another element or there may be an intermediate element therebetween. When an element is considered to be “connected to” another element, it can be directly connected to another element or there may be an intermediate element therebetween at the same time.

Unless otherwise defined, all technical and scientific terms used herein have the same meaning as commonly understood by one of ordinary skill in the technical field to which the present disclosure belongs. The terms used herein in the specification of the present disclosure are for the purpose of describing specific embodiments only, and are not intended to limit the present disclosure. As used herein, the term “and/or” includes any and all combinations of one or more of the associated listed items.

A lighting detection lamp assembly according to an embodiment of the present disclosure includes: an assembly body, a lighting source, and a detection signal source. The lighting source is provided in the assembly body, and is used for emitting lighting light to the outside. The detection signal source is provided in the assembly body, and is used for transmitting detection signals to the outside to detect orientations of objects around the assembly body.

A detection principle of detecting the orientations of surrounding objects lies in that, for example: the detection signal (such as infrared light) transmitted by the detection signal source can be reflected by a surface of the object when the detection signal encounters the object; and the reflected signal can be received by a detection receiver mounted on a vehicle body such as the front of a vehicle head; the vehicle console can determine the orientation of the object relative to the assembly body based on an incident angle of the reflected signal received by the detection receiver, and can calculate a distance between the object and the assembly body according to the time interval between receiving the reflected signal and transmitting the detection signal.

The above describes a method of detecting the orientations of surrounding objects by using the principle of light reflection. Certainly, in some other embodiments, other types of detection signals and corresponding receivers can also be used to detect and obtain the orientations of surrounding objects, which are fallen within the protection scope of the present disclosure.

In the above-mentioned lighting detection lamp assembly, the lighting source and the detection signal source are provided inside the assembly body, making full use of the space inside the assembly body, and the arrangement is compact, which is beneficial to the miniaturized design of the whole assembly body and facilitates later maintenance. In some embodiments, the lighting source and the detection signal source may adopt an integrated design. Signal transmission lines of the lighting source and the detection signal source may be bundled together to form a wiring harness. The wiring harness is provided neatly and orderly.

The detection signal source is provided inside the lamp assembly, and thus can be protected from being easily damaged by collision and impact. Since the detection signal source is provided inside the assembly body, the detection signal source will not be polluted by dust, which saves maintenance costs. In addition, after the lamp assembly has the detection function, it can ensure a sufficient detection angle range and reduce the detection blind spot, which is beneficial to the realization of the automatic following function and the reduced probability of the occurrence of collision accidents.

In addition, the lighting detection lamp assembly may further include a detection receiver. The detection receiver is configured to receive a reflected signal of the detection signal. In some embodiments, the detection receiver may be provided inside the assembly body, so that the space of the assembly body itself is further utilized, which is beneficial to the miniaturization and intensification of device manufacturing. When the detection signal transmitted by the detection signal source is, for example, an infrared laser light, an infrared camera can be selected as the detection receiver to receive the reflected signal.

The detection signal source and the lighting source can be provided in various specific forms in the assembly body, which will be described in detail below with reference to the accompanying drawings.

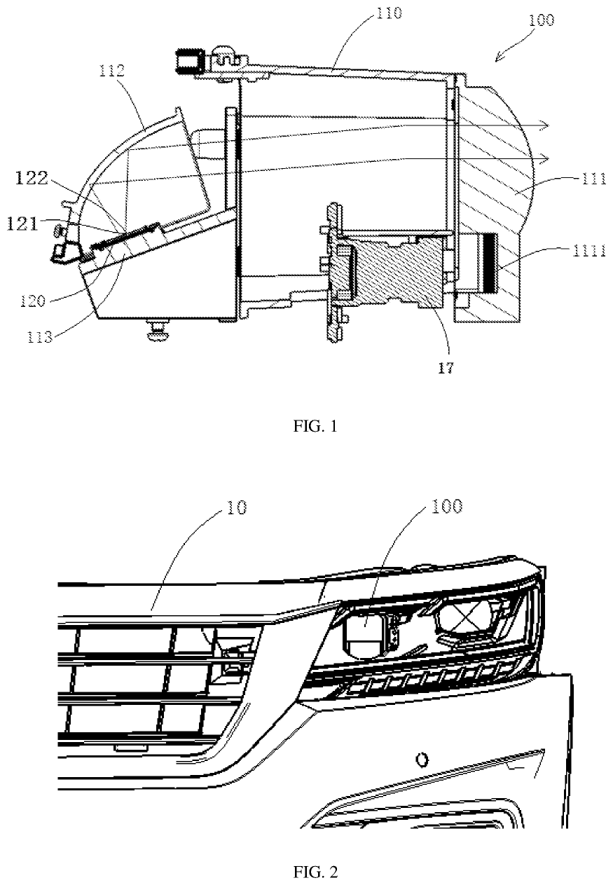

Referring to FIGS. 1 to 2, an embodiment of a lighting detection lamp assembly is shown. The lighting detection lamp assembly 100 includes an assembly body 110, a lighting source 121, and a detection signal source. The detection signal source is, for example, a detection light source that can emit detection light. For example, the detection signal source includes a first detection light source 122 for emitting first detection light. The first detection light source 122 and the lighting source 121 may be combined to form a composite light source 120. The combined composite light source 120 can emit the first detection light and the lighting light. The first detection light and the lighting light may be emitted at the same time or not at the same time.

In some embodiments, the first detection light source 122 and the lighting source 121 may be substantially at the same position, or positions of the first detection light source 122 and the lighting source 121 may be very close to each other. For example, a radiator 113 is further provided at the rear of the assembly body 110. The radiator 113 can be used to fix the first detection light source 122 and the lighting source 121. When the composite light source 120 operates, the radiator 113 can provide heat dissipation in time.

Since the first detection light source 122 and the lighting source 121 are combined to form the composite light source 120, the mounting space can be further saved, and the volume of the whole lamp assembly can be further reduced. In addition, by combining the first detection light source 122 and the lighting source 121 to form the composite light source 120 and then mounting the composite light source 120 in the assembly body 110, the light-emitting angles of the detection light source and the lighting source are also almost the same, so the emitted lighting light and the detection light can form two light spots with different wavelengths but with light energy distributions close to each other outside the assembly body 110. The two light spots at almost the same positions are used for lighting and detecting positions, respectively, so that the detection area and the lighting area can have the same range. That is, the area that the lighting light can irradiate can basically be detected.

In some embodiments, the composite light source 120 can also be directly configured as a light source assembly. The light source assembly can emit both the first detection light and the lighting light, which is simpler in design.

In practical application, as shown in FIG. 2, when the above-mentioned lighting detection lamp assembly 100 is provided in the front of the vehicle 10, the composite light source 120 continuously emits the first detection light to assist driving. Generally, it is not necessary to provide the lighting during the day. If the continuously emitted first detection light is visible light, the drivers and pedestrians approaching the opposite side of the vehicle 10 will be misled. Therefore, the composite light source 120 can be composed of a first detection light source 122 that can emit invisible light and a lighting source 121 that emits visible light. The invisible light can be infrared light, which can be continuously emitted as the first detection light when the vehicle is travelling. The visible light can be emitted as the lighting light for lighting only when needed.

Continuing to refer to FIG. 1, the lighting detection lamp assembly may further include a first detection receiver 17. The first detection receiver 17 is provided in the assembly body 110 and is used for receiving the reflected light of the first detection light reflected by an external object. After the composite light source 120 emits the first detection light, the first detection light is reflected after reaching the external object. The first detection receiver 17 receives the reflected light and performs data processing on the reflected light. In this way, the space of the assembly body 110 itself is further utilized. The first detection receiver 17 and the composite light source 120 are integrated and mounted in the assembly body 110, such that the whole configuration is more compact, which is beneficial to the miniaturization of the device manufacturing.

Certainly, in some other embodiments, the first detection receiver 17 may be provided separately from the assembly body 110 and provided at other positions on the vehicle head of the vehicle 10, which is not limited herein.

In some embodiments, the assembly body 110 may include a first optical design unit 112 and a first light transmission unit 111. The first optical design unit 112 may use a reflector, which is provided on a side of the composite light source 120 and located at the rear end of the assembly body 110, and configured to converge the lighting light and the first detection light emitted by the composite light source 120 to form a light beam transmitted in the assembly body 110. The light beam is transmitted through the first light transmission unit 111 at the front end of the assembly body 110 and is emitted outward at a certain angle. The two kinds of light (the lighting light and the first detection light) emitted by the composite light source 120 can be converged at the same time through the reflector. Since there is almost no interval between the first detection light source and the lighting source included in the composite light source 120, and the light-emitting angles of the first detection light source and the lighting source are almost the same, the emitted lighting light and the first detection light can form two light spots with light energy distributions close to each other but different wavelengths outside the assembly body 110, which are used for lighting and detecting, respectively, so that the detected first detection area and the lighting area can be basically the same.

It can be understood that, in addition to the reflector, the first optical design unit 112 can also use other optical components that can realize optical design, which is not limited herein. Certainly, in some other embodiments, the assembly body 110 may also not include the first optical design unit 112, as long as the light can be transmitted through the first light transmission unit 111 and be emitted out, which is not limited herein.

The first optical design unit 112 and the first light transmission unit 111 converge the lighting light and the first detection light and adjust the light beam, which can ensure that the lighting and detecting effects are controllable. The first optical design unit 112 and the first light transmission unit 111 with different shape parameters, as well as the distance parameter between the first optical design unit 112 and the first light transmission unit 111, can be specifically set according to different requirements, which can make the emitted light beams show different effects, and result in stable lighting and detecting effects, and which can adapt to different lighting and detecting requirements, and also simplify the structure of the whole lamp assembly and facilitate the use.

In some embodiments, the first light transmission unit 111 can select a convex lens with a larger thickness in the middle. The convex lens can adjust the light path. The lighting light and the first detection light can be emitted outward in a certain light shape after being adjusted by the convex lens.

In some embodiments, a light transmission area 1111 is provided on the first light transmission unit 111 at a position corresponding to the first detection receiver 17. The reflected light of the first detection light (e.g., infrared light) can be transmitted through the light transmission area 1111, enter the assembly body 110, and be received by the first detection receiver 17.

In some embodiments, the lighting source 121 may be a light-emitting diode (LED) light source. In some other embodiments, the lighting source can be a halogen light source, a high intensity discharge (HID) light source, a laser light source, etc., which are not limited herein. Since the lighting source 121 can be a variety of light sources, after the detection signal source and various lighting sources are integrated and designed, various vehicle lamps and lamp assembly products with composite functions can be provided, which is more beneficial to market promotion.

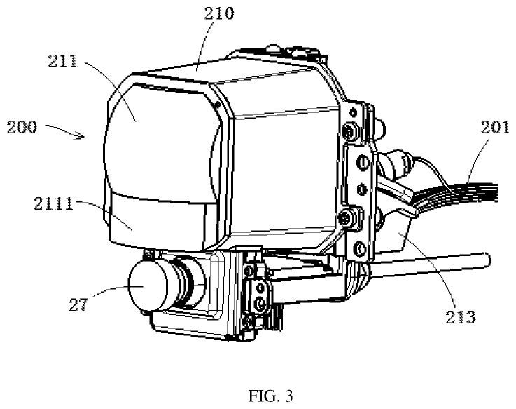

Referring to FIGS. 3 to 6, another embodiment of the lighting detection lamp assembly is shown. The lighting detection lamp assembly 200 includes an assembly body 210, a lighting source 221, and a detection signal source. The detection signal source may include a first detection light source 222 and a second detection light source 223. The first detection light source 222 is used for emitting first detection light, and the second detection light source 223 is used for emitting second detection light. This embodiment has some similarities with the above-mentioned embodiments. For example, the first detection light source 222 can be combined with the lighting source 221 to form a composite light source 220. The position and function of the composite light source 220 are, for example, substantially the same as those of the above-mentioned composite light source 120. For example, the composite light source 220 is mounted on a radiator 213. The lighting light and the first detection light emitted by the composite light source 220 can be converged by an optical design unit 212 to form a light beam and be emitted. The similarities between this embodiment and the above-mentioned embodiments will not be described in detail herein. Signal transmission lines of the second detection light source 223 can be bundled together to form a wiring harness 201. The wiring harness is provided neatly and orderly.

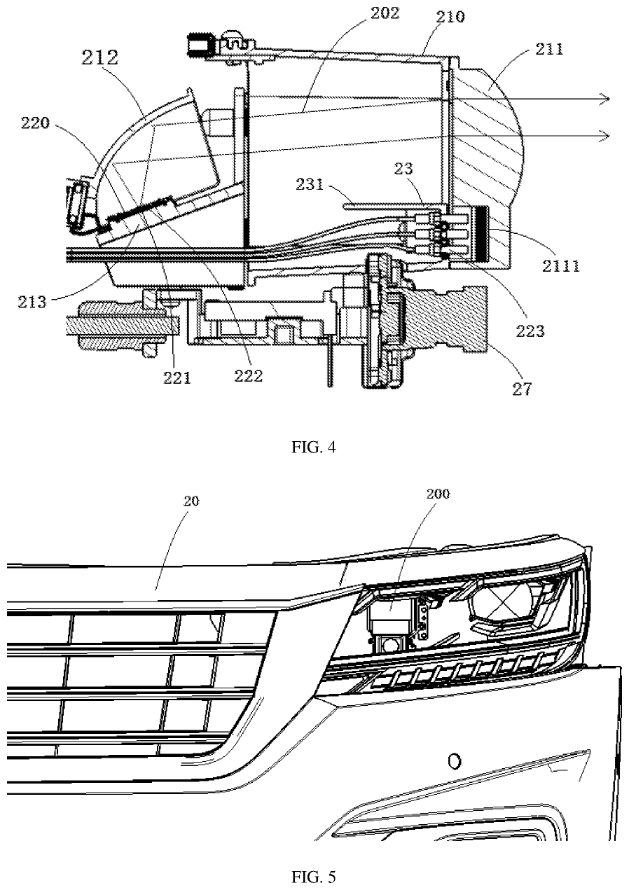

Referring to FIG. 4, the second detection light source 223 is separated from the composite light source 220. The second detection light source 223 detects an orientation of an object around the assembly body by the emitted second detection light. In FIG. 4, the second detection light source 223 is provided on a side of the composite light source 220. The assembly body 210 includes a second light transmission unit 211. The second light transmission unit 211 is used for allowing the lighting light, the first detection light, and the second detection light to be transmitted through, and be emitted outward at a certain angle. In some embodiments, the second light transmission unit 211 is provided with a first adjusting area (fine adjusting area) 2111. The first adjusting area 2111 can also be used to cause the second detection light emitted by the second detection light source 223 to be emitted outward according to a preset pattern. For example, the second detection light is uniformly emitted out with a certain width.

In some embodiments, the lighting light and the first detection light can be pre-converged by the optical design unit 212 into a light beam 202 transmitted in the assembly body 210. The light beam 202 is transmitted through the second light transmission unit 211 at the front end of the assembly body 210, and can be emitted outward at a certain angle. The first adjusting area 2111 may be a microstructure processed separately on a surface of the second light transmission unit 211. When the second detection light (e.g., infrared laser light) emitted by the second detection light source 222 enters the second light transmission unit 211, the microstructure can shape the second detection light, so that the second detection light transmitted through the second light transmission unit 211 forms an area array laser plane with a specific field of view, so as to achieve the adjustment of the second detection light.

In some embodiments, the second detection light source 223 may be provided on a side of the composite light source 220 or around the composite light source 220. Since the lighting light, the first detection light, and the second detection light use the same second light transmission unit 211 to adjust the light, so that one second light transmission unit 211 can be used to achieve both the lighting function and the detecting function, which can save the manufacturing cost of elements, and make the structure more compact after combination.

In some embodiments, the second light transmission unit 211 can select a convex lens with a larger thickness in the middle. The convex lens can adjust the light path. The lighting light and the detecting light can be emitted outward in a certain light shape after being adjusted.

In some embodiments, the second detection light source 223 is provided adjacent to a side of the second light transmission unit 211 or around the light transmission unit 111. According to the position of the second detection light source 223, the first adjusting area 2111 can be provided at an edge of the side of the second light transmission unit 211, or provided around the second light transmission unit 211. In this way, it is beneficial to the miniaturization and intensive design of the whole device.

In some embodiments, the second detection light source 223 is fixed to an inner wall of the assembly body 210 by, for example, a first fixing base 23. A first partition 231 is provided between the second detection light source 223 and the composite light source 120. The first partition 231 partitions the second detection light emitted by the second detection light source 223 from the light emitted by the composite light source 220. The second detection light emitted by the second detection light source 223 and the light emitted by the composite light source 120 do not interfere with each other. Therefore, the use effect can be prevented from being reduced due to the mutual interference of optical signals.

Referring to FIG. 5, when the lighting detection lamp assembly 200 is provided at the front of the vehicle 20, the composite light source 220 continuously emits the first detection light to assist driving, and the second detection light source 223 continuously emits the second detection light to assist driving. The composite light source 220 may emit lighting light as required. The first detection light and the second detection light are invisible light, such as infrared light.

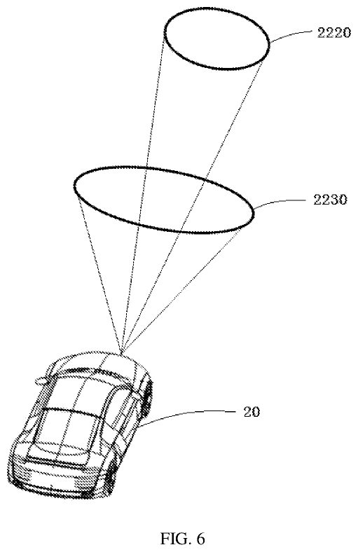

Referring to FIG. 6, in some embodiments, an irradiation width range of one of the first detection light and the second detection light is greater than an irradiation width range of the other of the first detection light and the second detection light, and an irradiation distance of the one is less than an irradiation distance of the other. For example, the irradiation width range of the second detection light 2230 is greater than the irradiation width range of the first detection light 2220, and the irradiation distance of the second detection light 2230 is less than the irradiation distance of the first detection light 2220.

Considering that when the energy emitted by the radar is constant, due to the distribution of the detection signal transmitted by the radar, generally, only wide detection area range can be selected, or the brightness is converged to obtain a longer detection distance. When the detection distance increases, a detection width will decrease, it is impossible to take into account the detection width and detection distance, which is not beneficial to the realization of the automatic following function, and is prone to accidental collisions. By providing the first detection light source 222 and the second detection light source 223 at the same time, one of them is used for short-range detection and the other is used for long-distance detection. During long-distance detection, a large detection width is not required (for example, the detection is mainly performed on a narrow range in the distance directly in front), while during short-distance detection, the detection range can be widened. Through reasonably configured, for example, the light emitted by the composite light source is focused and irradiated to a narrow area in the distance such that the first detection light 2220 can detect the orientation of the object in the narrow area in the distance, and the detection distance of the second detection light source 223 is adjusted and shortened. In this case, the second detection light 2230 can detect the orientation of object in a short distance and a wide range. Through the cooperation of the composite light source 220 and the second detection light source 223, sufficient detection distance and detection width can be ensured at the same time. The long detection distance is beneficial to obtain the distance from the host vehicle to the preceding vehicle in advance during high-speed driving, so that measures can be taken in advance to avoid accidents. A large detection width can ensure a sufficient detection angle range and narrow the detection blind spot, which is beneficial to the realization of the automatic following function and the reduction of the probability of collision accidents as a whole. Because the detection range is more comprehensive, it is more suitable for unmanned vehicles.

Certainly, in other embodiments, the second detection light source 223 can also be adjusted to emit the second detection light for detecting the orientation of the object within a long distance and narrow range, while the first detection light emitted by the composite light source 220 can be used for detecting the orientation of the object in a short distance and a wide range.

The second detection light source 223 is provided inside the assembly body 210, so as to be protected from not being easily damaged by collision and impact, and from being polluted by dust, which saves maintenance costs.

In some embodiments, the first detection light source 222 and the second detection light source 223 may be infrared lasers. The second detection light source 223 can be fixed on the inner wall of the assembly body 210 through the first fixing base 23. The first fixing base 23 is provided with the first partition 231 for partitioning the second detection light source 223 from the composite light source 220. A plurality of infrared lasers used as the second detection light source 223 are respectively fixed on the first fixing base 23, and then the first fixing base 23 is placed in the assembly body 210, and front ends of the infrared lasers face the first adjusting area 2111 on the second light transmission unit 211, so that the infrared laser light emitted by the infrared lasers can be uniformly adjusted by the first adjusting area 2111, and then transmitted through the second light transmission unit 211, and emitted out uniformly. The first partition 231 partitions the infrared lasers and the composite light source 120, thereby reducing the probability of mutual interference between the infrared laser light emitted by the infrared laser and the light emitted by the composite light source 120, resulting in a better use effect.

Continuing to refer to FIG. 4, the lighting detection light assembly may further include a second detection receiver 27. The second detection receiver 27 may be, for example, an infrared camera. The second detection receiver 27 is attached to the assembly body 210 and is located outside the second light transmission unit 211, and is used for receiving the reflected light of the first detection light and the reflected light of the second detection light. The second detection receiver 27 is provided adjacent to the assembly body 110, which is beneficial to the miniaturization and intensive design of the whole device. In addition, the infrared laser emits the infrared laser light to realize the infrared area array detection. The infrared camera performs detection by receiving the reflected light of the infrared area array laser light, that is, forming a flash LiDAR. The emitted infrared laser light can be a light pulse or a continuous wave. When the light pulse is emitted, a pulse width of the pulse can be specially modulated to ensure that the infrared lasers do not interfere with each other when the plurality of infrared lasers are operating at the same time.

In some other embodiments, the first detection light source 222, the second detection light source 223, and the second detection receiver 27 may also adopt other radar technology solutions, such as micro-electro-mechanical system (MEMS) scanning Lidar, mechanical galvanometer scanning Lidar, and optical phased array (OPA) Lidar, etc., and which are not limited herein.

In some other embodiments, the second detection receiver 27 may be provided separately from the assembly body 210 and provided on other parts of the vehicle head of the vehicle 20, and which is not limited herein.

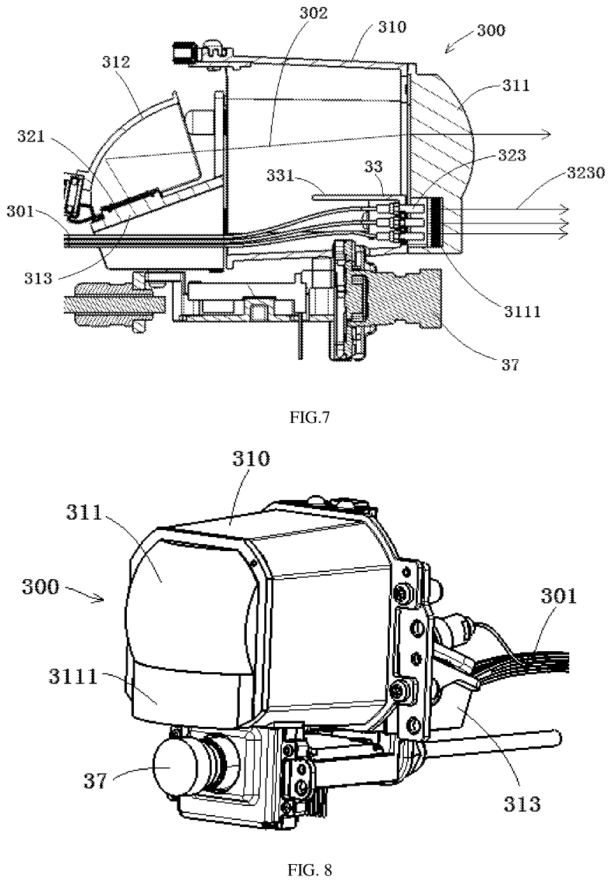

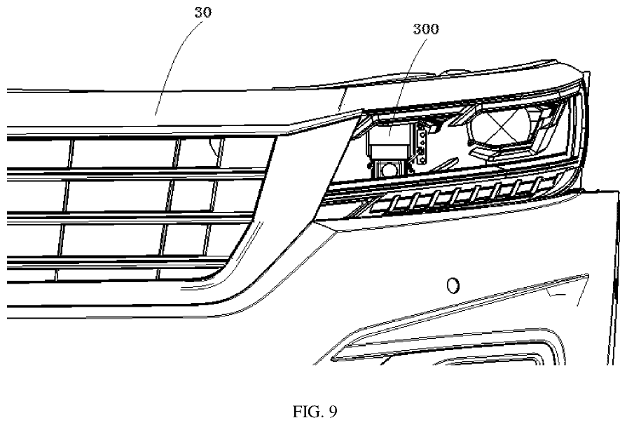

Referring to FIGS. 7 to 9, yet another embodiment of a lighting detection lamp assembly 300 is shown. The lighting detection lamp assembly 300 may be mounted in the front of the vehicle 30. The detection signal source includes a third detection light source 323 provided in the assembly body 310 separately from the lighting source 321. The third detection light source 323 can emit third detection light for detecting an orientation of an object around the assembly body 310. The lighting source 321 can be mounted on a radiator 313. The third detection light source 323 is provided on a side of the lighting source 321. The assembly body 310 includes a second optical design unit 312 and a third light transmission unit 311. Lighting light 302 emitted by the lighting source 321 can be transmitted through the third light transmission unit 311, and be emitted outward at a certain angle. The third light transmission unit 311 is provided with a second adjusting area 3111. The second adjusting area 3111 is used to cause the third detection light to be emitted outward according to a preset pattern. For example, the third detection light is uniformly emitted with a certain width. The lighting source 321 and the third detection light source 323 can adopt an integrated design. The signal transmission lines of the lighting source 321 and the third detection light source 323 can be bundled together to form a wire harness 301, and the wiring harness is provided neatly and orderly.

The lighting light emitted by the lighting source 321 is converged by the second optical design unit 312 such as a reflector into a light beam transmitted in the assembly body 310. The light beam is transmitted through the third light transmission unit 311 at the front end of the assembly body 310 and is emitted outward at a certain angle. The second adjusting area 3111 can be a microstructure such as a pattern that is separately processed on a surface of the third light transmission unit 311. When the third detection light 3230 (e.g., infrared light) enters the third light transmission unit 311, the second adjusting area 3111 can shape the third detection light 3230, so that the third detection light 3230 transmitted through the third light transmission unit 311 forms an area array laser plane with a specific field of view, so as to achieve the adjustment of the third detection light 3230.

In some embodiments, the third detection light source 323 may be provided on a side of the lighting source 321 or around the lighting source 321. The third detection light 3230 and the lighting light 302 use the same third light transmission unit 311 to adjust the light, so that one third light transmission unit 311 can be used to achieve both the lighting function and the detection function, which can save the manufacturing cost of elements and make the structure more compact after combination.

In some embodiments, the third detection light source 323 is provided adjacent to a side of the third light transmission unit 311 or around the third light transmission unit 311. According to the position of the third detection light source 323, the second adjusting area 3111 is provided at an edge of the side of the third light transmission unit 311 or provided around the third light transmission unit 311. In this way, it is beneficial to the miniaturization and intensive design of the whole device.

In some embodiments, the third detection light source 323 is fixed to an inner wall of the assembly body 110, and a second partition 331 is provided between the third detection light source 323 and the lighting light 302. The second partition 331 partitions the third detection light 3230 from the lighting light 302, so that the third detection light 3230 emitted by the third detection light source 323 and the lighting light 302 do not interfere with each other, thereby preventing mutual interference of optical signals from reducing the use effect.

The third detection light source 323 may include one or more infrared lasers. The infrared lasers are fixed to the inner wall of the assembly body 310 through a second fixing base 33. The second partition 331 for partitioning the third detection light source 323 from the lighting light 302 is provided on the second fixing base 33. As shown in figures, the plurality of infrared lasers are respectively fixed on the second fixing base 33, and then the second fixing base 33 is placed in the assembly body 310, and front ends of the infrared lasers face the second adjusting area 3111 on the third light transmission unit 311. The infrared laser light emitted by the infrared lasers are uniformly adjusted by the second adjusting area 3111, and are then transmitted through the third light transmission unit 311, and are emitted out uniformly. The second partition 331 partitions the infrared lasers and the lighting light 302, thereby reducing the probability of mutual interference between the infrared laser light emitted by the infrared laser and the lighting light 302, which is beneficial to improve the use effect.

A third detection receiver 37 may be attached to the assembly body 310 and located outside the third light transmission unit 311. The infrared laser may be used in cooperation with the third detection receiver 37 such as an infrared camera. For example, the infrared camera is provided on a side of the assembly body 110. Through this configuration, the infrared camera is adjacent to the assembly body 310, which is beneficial to the miniaturization and intensive design of the whole device. In addition, the infrared laser emits the infrared laser light to realize the infrared area array detection. The infrared camera performs detection by receiving the reflected light of the infrared area array laser light, that is, forming a flash LiDAR. The emitted infrared laser light can be a light pulse or a continuous wave. When the light pulse is emitted, a pulse width of the pulse can be specially modulated to ensure that the infrared lasers do not interfere with each other when the plurality of infrared lasers are operating at the same time.

The infrared laser light emitted by the infrared lasers can have various wavelengths, which can preferably be 905 nm, 940 nm or 1550 nm. The infrared laser light with the wavelengths of 905 nm and 940 nm are located in a weak part of the wavelength energy distribution of sunlight, which can increase the signal-to-noise ratio of the system. It is advantageously to use the wavelength of 1550 nm, because the wavelength of 1550 nm is located in a weaker part of the wavelength energy distribution of sunlight, and is safer for the human eye, which can further improve the power output of an emitting end and achieve a longer detection distance.

It can be understood that, in some other embodiments, the third detection light source 323 and the third detection receiver 37 may also adopt other radar technology solutions, such as MEMS scanning Lidar, mechanical galvanometer scanning Lidar, and optical phased array (OPA) Lidar, etc., and which are not limited herein.

It should be noted that, although the detection signal source in the above embodiments is described by taking the detection light source as an example, it can be understood that in practical applications, the implementation of the detection signal source is not limited to the detection light source, and can also be achieved with any other suitable technology. The above-mentioned first detection light source, second detection light source, and third detection light source can all be replaced by other detection signal sources. Depending on the type of the detection signal source, the type of the detection receiver used to receive the detection signal source also changes accordingly.

In an unshown embodiment, a plurality of detection signal sources may be provided. At least one detection signal source is used to transmit a first detection signal with a first width range and a first distance range to the outside, and at least one detection signal source is used to transmit a second detection signal with a second width range and a second distance range to the outside. The first width range is greater than the second width range, and the first distance range is less than the second distance range. In this way, sufficient detection distance and detection width can be ensured at the same time, and the detection range is more comprehensive, which is especially suitable for unmanned vehicles.

The technical features of the above described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. The protection scope of the present disclosure shall be subject to the appended claims.

What is claimed is:

1. A lighting detection lamp assembly, comprising:
an assembly body;
a lighting source provided in the assembly body and configured to emit lighting light to outside; and
a detection signal source provided in the assembly body and configured to transmit a detection signal to the outside to detect an orientation of an object around the assembly body.

2. The lighting detection lamp assembly according to claim 1, wherein the detection signal source comprises a plurality of detection light sources; and the plurality of detection light sources are capable of emitting detection light for detecting the orientation of the object around the assembly body.

3. The lighting detection lamp assembly according to claim 1, wherein the detection signal source comprises a first detection light source, the first detection light source is configured to emit first detection light; the first detection light source and the lighting source are combined to form a composite light source; and the composite light source is configured to emit the lighting light and the first detection light.

4. The lighting detection lamp assembly according to claim 3, wherein,
the assembly body comprises a first light transmission unit; the first light transmission unit is configured to allow the lighting light and the first detection light to be transmitted through so as to be emitted outward;
the lighting detection lamp assembly further comprises a first detection receiver provided in the assembly body;
a light transmission area is provided on the first light transmission unit at a position corresponding to the first detection receiver; and the light transmission area is configured to allow reflected light of the first detection light to be transmitted through so as to be received by the first detection receiver.

5. The lighting detection lamp assembly according to claim 3, wherein the detection signal source further comprises a second detection light source; the second detection light source is capable of emitting second detection light for detecting the orientation of the object around the assembly body; and a first partition is provided between the second detection light source and the composite light source.

6. The lighting detection lamp assembly according to claim 5, wherein the assembly body comprises a second light transmission unit; and the second light transmission unit is configured to allow the lighting light, the first detection light, and the second detection light to be transmitted through so as to be emitted outward.

7. The lighting detection lamp assembly according to claim 6, wherein the second light transmission unit is provided with a first adjusting area; and the first adjusting area is configured to cause the second detection light to be emitted outward according to a preset pattern.

8. The lighting detection lamp assembly according to claim 7, wherein the first adjusting area is located at an edge of at least part of a side of the second light transmission unit.

9. The lighting detection lamp assembly according to claim 5, wherein the second detection light source is fixed to an inner wall of the assembly body by a first fixing base; and the first partition is formed on the first fixing base.

10. The lighting detection lamp assembly according to claim 5, wherein an irradiation width range of one of the first detection light and the second detection light is greater than an irradiation width range of the other of the first detection light and the second detection light; and an irradiation distance of the one is less than an irradiation distance of the other.

11. The lighting detection lamp assembly according to claim 5, further comprising a second detection receiver; wherein the second detection receiver is attached to the assembly body and is located outside the second light transmission unit, and configured to receive reflected light of the first detection light and reflected light of the second detection light.

12. The lighting detection lamp assembly according to claim 3, wherein the assembly body further comprises a first optical design unit; the first optical design unit is configured to converge the lighting light and the first detection light to form a light beam transmitted in the assembly body.

13. The lighting detection lamp assembly according to claim 12, wherein the first optical design unit comprises a reflector.

14. The lighting detection lamp assembly according to claim 1, wherein the assembly body further comprises a radiator configured to fix the lighting source and provide heat dissipation for the lighting source.

15. The lighting detection lamp assembly according to claim 1, wherein the detection light source comprises one or more infrared lasers.

16. The lighting detection lamp assembly according to claim 1, further comprising a detection receiver configured to receive a reflected signal of the detection signal.

17. The lighting detection lamp assembly according to claim 1, wherein the detection signal source comprises a third detection light source; the third detection light source is capable of emitting third detection light for detecting the orientation of the object around the assembly body; the third detection light source is separated from the lighting source.

18. The lighting detection lamp assembly according to claim 17, wherein the assembly body comprises a third light transmission unit; the third light transmission unit is configured to allow the lighting light and the third detection light to be transmitted through so as to be emitted outward.

19. The lighting detection lamp assembly according to claim 18, wherein the third light transmission unit is provided with a second adjusting area; and the second adjusting area is configured to cause the third detection light to be emitted outward according to a preset pattern.

20. The lighting detection lamp assembly according to claim 19, wherein the second adjusting area is located at an edge of at least part of a side of the third light transmission unit.

21. The lighting detection lamp assembly according to claim 17, wherein the third detection light source is fixed to an inner wall of the assembly body; and a second partition is provided between the third detection light source and the lighting light.

22. The lighting detection lamp assembly according to claim 17, further comprising a third detection receiver; wherein the third detection receiver is attached to the assembly body and located outside the third light transmission unit, and configured to receive reflected light of the third detection light.

23. The lighting detection lamp assembly according to claim 17, wherein the assembly body further comprises a second optical design unit; the second optical design unit is configured to converge the lighting light to form a light beam transmitted in the assembly body.

24. The lighting detection lamp assembly according to claim 23, wherein the second optical design unit comprises a reflector.

25. The lighting detection lamp assembly according to claim 1, wherein a plurality of detection signal sources are provided; at least one detection signal source is configured to transmit a first detection signal with a first width range and a first distance range to the outside, and at least one detection signal source is configured to transmit a second detection signal with a second width range and a second distance range to the outside; wherein the first width range is greater than the second width range, and the first distance range is less than the second distance range.

26. A vehicle, comprising the lighting detection lamp assembly according to any one of claims 1 to 25.
